(19) United States
(12) Patent Application Publication
(10) Pub. No.: US 2005/0289047 A1
(43) Pub. Date: Dec. 29, 2005

(54) Virtual marketplace for wireless device applications and services with integrated multi-party settlement

(76) Inventors: Mitchell B. Oliver, San Diego, CA (US); Gerald Charles Horel, Brentwood Bay (CA); Julie Yu, San Diego, CA (US); Michelle Klein, San Diego, CA (US); Matthew Small, San Diego, CA (US); Susan L. Wake, Escondido, CA (US)

Correspondence Address: QUALCOMM, INC, 5775 MOREHOUSE DR., SAN DIEGO, CA, 92121, US

(21) Appl. No.: 10/880,309

(22) Filed: Jun. 28, 2004

(51) Int. Cl. G06Q 40/00

(52) U.S. Cl. 705/39

(57) ABSTRACT

A system, method, and computer program for providing independently developed applications and services to wireless telecommunication device users in a wireless communications network. The system allows independent developers to provide their applications and services to wireless device end-users via the wireless carrier network, bill a carrier and/or a subscriber for the application or service, and share in the revenues with the developer.

### BACKGROUND OF THE INVENTION

The present invention generally relates to wireless telecommunications and computer networks. More specifically, the present invention relates to a system and method for providing an infrastructure for delivering services through a wireless telecommunications network.

Wireless devices, such as cellular telephones, communicate packets including voice and data over a wireless network. In existing wireless telecommunication systems, such as cellular telecommunication systems, fees are charged to the subscriber for the initial activation of a telecommunication device and then fees can be charged for ongoing airtime and device usage. However, existing systems typically do not account for other activities at the telecommunication device beyond airtime usage.

Further, if the subscriber of the wireless device desires to download and use a software application or upgrade the functionality of the telecommunication device, the user will typically either call a service provider or contact the service provider through another electronic means, such as through a separate Internet access. In some instances, the service provider can transmit the application to the wireless device across the wireless network (through a one time direct access download) or allow the user access a network site with the wireless device through the wireless network and at such site the application is downloadable or accessible to the subscriber. Otherwise service personnel of the provider must have physical access to the telecommunication device to install the software or upgrade the components thereof.

Further, the proliferation of computer technology has made it easier and cheaper to develop software application. A computer programmer can easily develop a video game or a utility application on a personal computer, and the programmer can tailor the game to run on different computer hardware platforms including on a wireless handset. However, the individual application developer encounters difficulty in getting the product to market, especially for applications that are executable on wireless devices. The developer must first create a full version of the application and then sell it to the carriers in order to derive any income. Consequently, creating application for the wireless device market is a huge investment by the developer without the guarantee of return.

Accordingly, it would be advantageous to provide a system and method that allows individual developers to bring their products and applications to the marketplace and make these products and applications available to wireless service subscribers. Such system should allow wireless services providers to give means for the subscribers to access applications while including the application developer in the proceeds generated from the additional services provided. It is thus to such a system and method for providing such a virtual marketplace that the present invention is primarily directed.

### SUMMARY OF THE INVENTION

The present invention discloses a system and method for providing a virtual marketplace that supports transactions among multiple parties. The virtual marketplace allows independent software developers to sell their applications and services to network carriers and/or end-users of wireless device through a virtual marketplace. The system includes one or more wireless telecommunication devices where each wireless device selectively interacts with other computer devices on the wireless network and selectively downloads and executes applications, and at least one billing server is on the wireless network. The virtual marketplace is hosted by a computer device on the wireless network, which can be the billing server, and lists one or more applications or services that are accessible by carriers and end-users on wireless devices. Upon receiving a selection from a carrier or end-user for interaction with at least one of the applications, the billing server generates a bill for that end-user interaction. The billing server can then collect proceeds from the carrier or the end-user through electronic payment or other methods, and distribute a portion of the proceeds to the appropriate application developer for the carrier end-user interactions with that developer's applications.

The method for providing a virtual marketplace that provides access to one or more applications or services from developers and is accessible through a wireless network by carriers and wireless devices includes at least the steps of listing one or more applications in a the virtual marketplace, receiving a selection from a carrier or end-user for interaction with at least one of the applications in the virtual marketplace, and generating a bill for the end-user interaction with the at least one application. The method can further include the steps of receiving proceeds for the interaction, and distributing at least a portion of the proceeds to each developer for each interaction with the at least one application of that developer.

The present system and method thus enable individual developers to bring their applications and service to an existing wireless device marketplace and available to wireless service subscribers without needing to posses the requisite infrastructure. Through use of the system and method, the wireless services providers can more easily give value-added services of third parties to their subscribers and can include the third party application developer in the proceeds generated from the additional services provided.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a system diagram depicting an embodiment of telecommunication system that supports the virtual marketplace system.

FIG. 2 is a block diagram illustrating one embodiment of the interface architecture between the developers, carriers, and wireless devices.

FIG. 3 is a flowchart illustrating a submission process of a developer application to the virtual marketplace and the price negotiation thereof.

FIG. 4 is a flowchart illustrating an embodiment wherein an end-user orders an application or service from the virtual marketplace.

FIG. 5 is a flowchart illustrating one embodiment of a billing server process of tracking and billing for a subscription or billable event by a wireless device purchasing a third party application or service.

FIG. 6 is a block diagram illustrating an embodiment of the components of a billing server.

FIG. 7 is a diagram illustrating a multi-party settlement map.

### DETAILED DESCRIPTION OF THE INVENTION

In this description, the terms “communication device,” “wireless device,” “hand held telephone,” and “handset” are used interchangeably, the terms “server” and “virtual marketplace” are used interchangeably, and the term “application” as used herein is intended to encompass executable and nonexecutable software files, raw data, aggregated data, patches, and other code segments. Further, like numerals refer to like elements throughout the several views. With advent of 3^{rd} generation (3G) wireless communication technology, more bandwidth becomes available for wireless communications, and handsets and wireless telecommunication devices, such as cellular telephones, pagers, personal digital assistants (PDAs) with increasing capabilities have become available. Now, users can check weather, receive e-mails, receive paging messages, traverse the Internet, and play an interactive game with a remote party all through his wireless handset, in addition to using it for maintaining audio communications with another party. At the same time, proliferation of computer technology has made easier and cheaper to develop digital media and deliver it to the wireless devices. The provision of more value added services, such as downloadable applications, can bring revenue to a wireless service provider or carrier, and one manner to achieve the additional revenue is to provide support to independent application developers. The present invention thus provides at least billing support for third party independent application developer's provision of applications and servers to end-users of an independent network carriers telecommunication system as is further described herein.

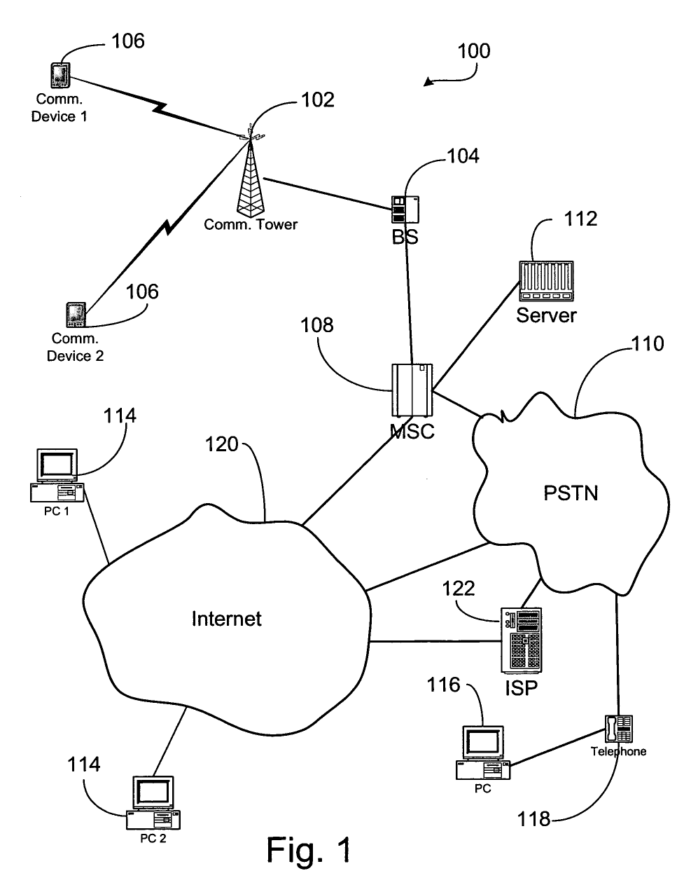

FIG. 1 depicts a communication network 100 used according to the present invention. The communication network 100 includes a wireless communications network, a public switched telephone network (PSTN) 110, and the Internet 120. The wireless communication network includes one or more communication towers 102, each connected to a base station (BS) 104 and serving users with communication devices 106. The communication devices 106 can be cellular telephones, pagers, personal digital assistants (PDAs), laptop computers, or other hand-held, stationary, or portable communication device that uses a wireless and cellular telecommunication network. The commands and data input by each user are transmitted as digital data to a communication tower 102. The communication between a user using a communication device 106 and the communication tower 102 can be based on different technologies, such code division multiplexed access (CDMA), time division multiplexed access (TDMA), frequency division multiplexed access (FDMA), global system for mobile communications (GSM), or other protocols that may be used in a wireless communications network or a data communications network. The data from each user is sent from the communication tower 102 to a base station (BS) 104, and forwarded to a mobile switching center (MSC) 108, which may be connected to a public switched telephone network (PSTN) 110.

The PSTN 110 is connected to the Internet 120 and to the wireless communication network through a MSC 108. The PSTN 110 supports users accessing the Internet using a computer 116 through dial up services. The user utilizes the computer 116 and dials through a telephone line 118 to access an Internet service provider (ISP) 122. The ISP 122 provides connection between the user at the computer 116 and the Internet 120. Users at computers 114 may also access directly the ISP 122 through high-speed data connections such as digital subscriber line (DSL), T1 connections, and the like. The Internet 120 is a high-speed data network. A user may access the Internet directly by connecting to a hub on the Internet 120 or access through an ISP 122 connected to the Internet 120. A server 112 may be connected to the Internet 120, to the MSC 108, or to the PSTN 110. Preferably, the server 112 is connected directly to the MSC 108.

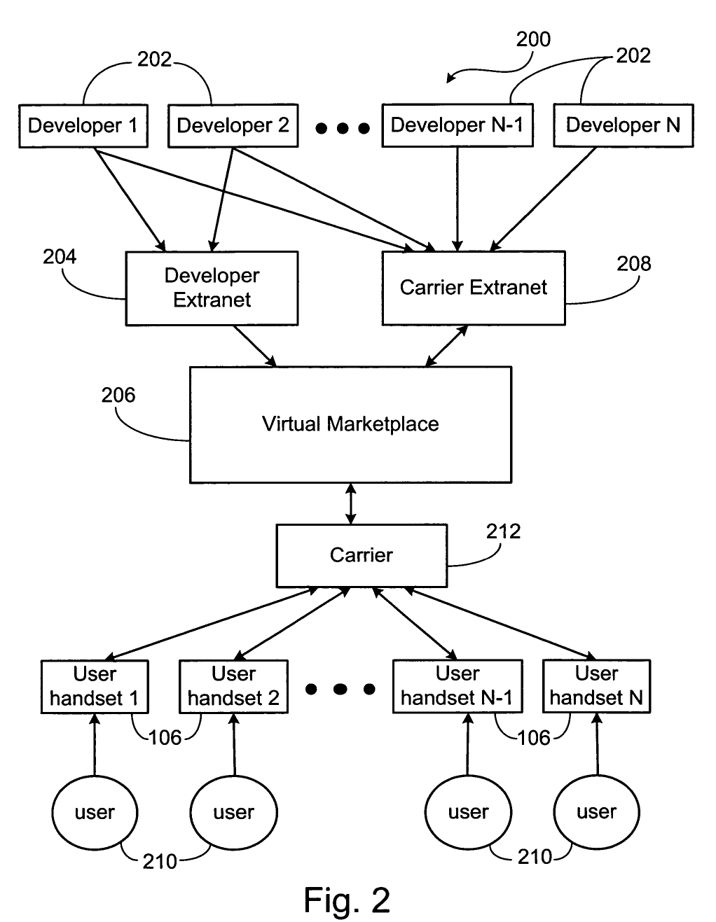

FIG. 2 is an interface architecture 200 that depicts data flow in the virtual marketplace. The developers 202, who generally having access to a computer 114 or 116, can submit their products through an interface 204, also known as the developer extranet, to the virtual marketplace 206, which resides on a server 112, which can be the server providing the entire virtual marketplace with full billing and collection of proceeds as is further defined herein. The developers 202 may also submit their products through a carrier extranet 208, which then forwards to the virtual marketplace 206. The interface 204 may be a web site in communication with the server or a file transfer protocol (FTP) conforming port on the server 112. The carrier extranet 208 may be an interface to the carrier's private network.

It is preferable that before a developer 202 is allowed to submit his product, such as an application, to the virtual marketplace 206, the developer 202 must certify that the product conforms to the standards established by the virtual marketplace 206. The virtual marketplace 206 publishes a set of standards for its environment that should be followed by developers who wish to submit their products to the virtual marketplace 206. Standardizing the products ensures the product can run without problems on a user handset that supports the virtual marketplace's environment. One example of such environment is Binary Runtime Environment for Wireless (BREW™) and BREW Distributed System (BDS) developed by Qualcomm Corporation. The product may also be required to be tested for conformance by a third party testing organization such as National Software Testing Labs (NSTL).

After the developer 202 submits the product, the carrier 212, through the virtual marketplace 206, can negotiate the price for the product with the developer 202. In one embodiment, the developer 202 and carrier 212 can perform an entity-to-entity price plan negotiation in the virtual marketplace 212. Moreover, the developer 202 can have independent negotiations with multiple carriers with a different price plan structure for the same application within in the same virtual marketplace 212. It should be noted that the price plan structure can be negotiated for different currencies and potential for barter of services between the developer and carrier, or any other potential exchange for value. The negotiation may be conducted directly between carrier 212 and the developers 202, through the carrier extranet 208 and the developers 202, or between the virtual marketplace 202 itself and the developers 202. If the carrier 212 is purchasing the application and making it available to that carrier's wireless subscribers, the product can be included in a product catalog and made available to the end-users 210 of communication devices 106. In relation to the price between the developers 202 and carriers 212, the mutually agreed to product price structure is stored in the virtual marketplace 206 and propagated with the suppliers product catalog, to their end-user consumer purchases of the product, through processing of carrier payment to the developer. The server 112 can track the catalog to the wireless device 106 to ensures the developer is paid based the agreed to price plan structure in effect at that time. Typically, the carrier 212 manages an independent list price to their wireless service subscribers (end-user consumers of the virtual marketplace 212) which is different from the price negotiated between the carrier 212 and developer 202.

An end-user 210 who accesses the wireless telecommunications services through the carrier 212 receives the product catalog from the carrier 212 as part of the subscription service. The end-user 210 can view the product catalog and select a product from the product catalog. The step of “selection” can be an application download, menu display, data transfer, diagnosis tool, upgrade, demonstration, subscription, pre-install, or any other computer interaction between the wireless device 106 and server 112 or other communication device. And the pricing structure to the end-user can be a flat-fee per transaction, and can also be based upon number of uses of the application or service by that end-user, the number of days the application or service is operational (e.g. an application that is usable for 90 days), the duration of use of the application, or any other known method to bill for value-added computer applications and services. Thus, through the virtual marketplace 206, the developer 202 can to host its applications in a single virtual store and control what suppliers (i.e., carriers) have visibility to sell that developer's 202 product.

The selection is sent from the user handset 106 to the carrier 212, which can transmit the ordered application to the end-user, or in another embodiment, can forward the request to the server 112 if the application is not resident at the carrier 212. The server 112 checks the selection and retrieves the product. The product is dispatched to the end-user handset 106 via the carrier 212. After receiving the product, the user 210 can activate it on his handset 106. For certain products, the carrier 212 or server 112 need not to dispatch the entire product to the user device 106, but only a user interface portion of the product. The user interface interacts with the user 210 through the user handset 106 and sends information back to the server 112 where the product runs.

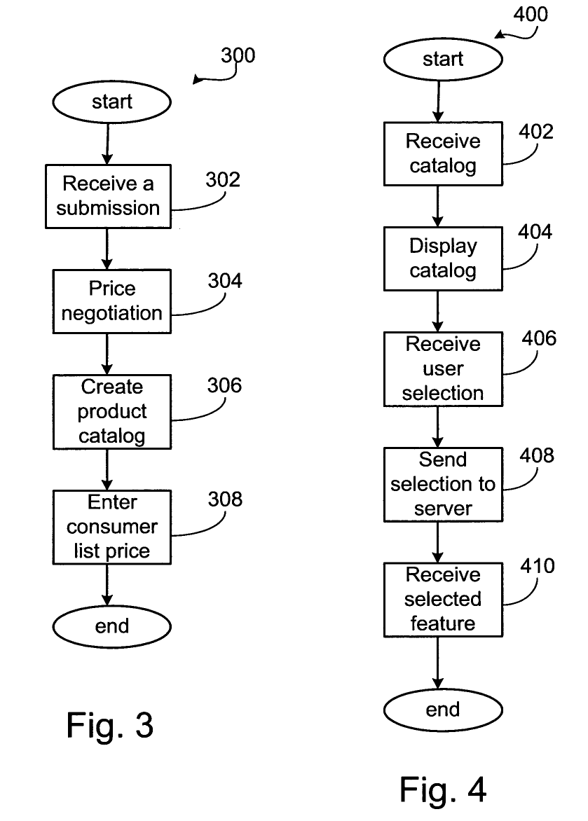

FIG. 3 illustrates one embodiment of the developer application submission process 300 and price negotiation wherein developer submits an application to the virtual marketplace 206. The virtual marketplace 206 receives a product submission from a developer 202 located remotely, as shown at step 302. The product can be sent by the developer 202 electronically through a network to the developer extranet 204. The developer 202 can also submit the product to a testing center for testing prior to submitting to the virtual marketplace 206. After the product passes the conformance testing, the testing center then sends the product to the virtual marketplace 206.

The virtual marketplace 206 negotiates the price with the developer 202 after the product is received, as shown at step 304, and such negotiation further described above. As earlier stated, the price scheme paid to the developer may be different from the price schemed billed to the users 210. The price paid to the developer may be a fixed amount, a percentage of what is charged to the users, a combination of fixed price and a percentage, and the like.

After the price agreement is reached between the developer 202 and the carrier 212 within the virtual marketplace 206, the virtual marketplace 206 creates a product catalog for the product or includes the product in an existing catalog, as shown at step 306. The virtual marketplace 206 may maintain several product catalogs that list products available to carriers 212 or directly to wireless devices 106, and the products are listed in these catalogs by category. The virtual marketplace 206 may maintain, for example, a catalog for software products and another separated catalog for consumer goods. Before making the product available to the users 210, the virtual marketplace 206 sets an end-user price for the product and enter the product in the price list, as shown at step 308.

FIG. 4 illustrates one embodiment of an end-user process 400 at the wireless device 106. When the handset 106 is powered up and in communication with the carrier, the handset 106 receives a catalog of products and services from the carrier 212 that are available to the user, as shown at step 402, and displays the catalog on the handset's display screen, as shown at step 404. The products and services available to the user may include interactive games, personal appointment applications, and other utility programs. The user can select a product from the catalog, and the selection is received by the handset 106, as shown at step 406. The handset 106 sends the user selection to the carrier 212, as shown at step 408, through a data channel, and in this embodiment, the carrier 212 forwards the selection along with the user information to the server 112 of the virtual marketplace. The server 112 retrieves the selected product and dispatches to the user handset 106. When the user handset 106 receives the product, as shown at step 410, the user handset 106 activates the product for the user. Alternately, if the product was resident at the carrier 212, then the product would simply have been sent from the carrier after the request at step 408. A “price handle id” can be propagated with the catalog and end-user application download to enforces the developer payment's being processed against the “negotiated” developer price in the virtual marketplace 206. A “price handle id” propagation with the catalog enables a single application to change the price plans and transactions to mediate to the price plan that was in effect at the time of the application download. Therefore, the billing server can mediate several different price handles at one time due to the asynchronous transaction propagation. For example, queued downloaded applications that reference older price handles can be collected with recent downloads that reference the “current” price handle in the catalog.

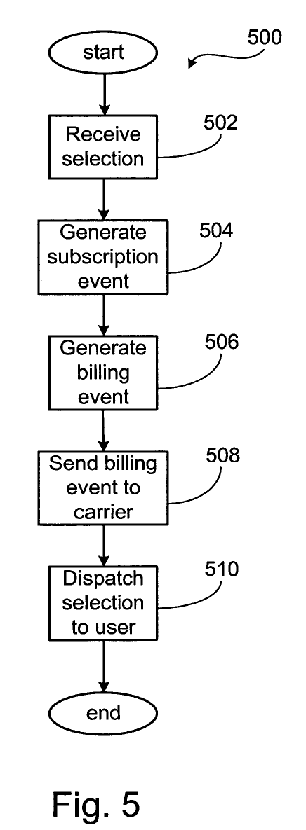

FIG. 5 illustrates one embodiment of the process 500 executing on a server providing a virtual marketplace 206, specifically for a subscription event. The server 112 receives the user selection from the carrier 212, as shown at step 502, along with the user information, and generates subscription information, as shown at step 504. For example, the subscription may be one time subscription or a monthly subscription, and the end-user can have the option of pay per use or monthly subscription. The server 112 also generates billing information, as shown at step 506, and sends the billing information to the carrier 212, as shown at step 508. The carrier uses the billing information to bill the user 210. Finally, the server 112 retrieves the selected product and sends it to the handset 106, as shown at step 510. In another embodiment, server 112 can be a carrier 212 device both providing applications to the wireless device 106 and billing for the application.

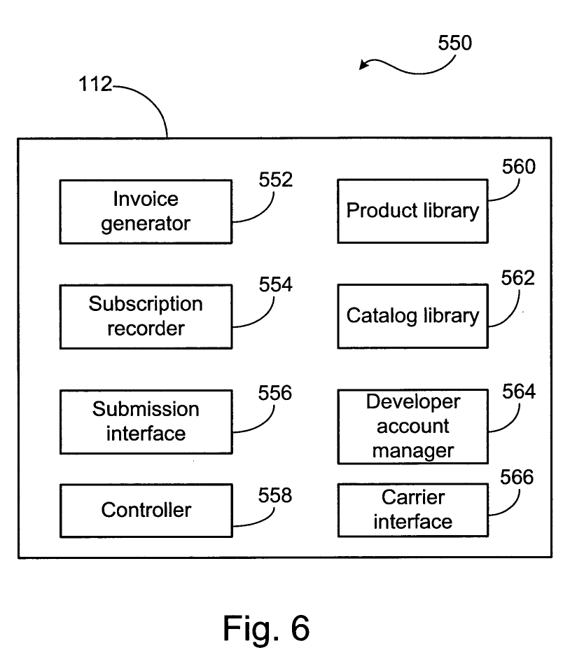

FIG. 6 illustrates one embodiment of the components of a server 112 providing a virtual marketplace. The server 112 has an invoice generator 552, a subscription recorder 554, a submission interface 556, a controller 558, a product library 560, a catalog library 562, a developer account manager 564, and a carrier interface 566. The invoice generator 552 generates invoices to the carriers; the transaction recorder 554 records user selections such as subscriptions; the developer interface 556 receives product submissions from and interacts with developers; the product library 560 stores all the products submitted; the catalog library 562 stores all the catalogs devised for different carriers and hardware platforms; the developer account manager 564 provides subscription information or other data to the developers and makes payments to the developers; the carrier interface 566 interfaces with the carriers; and the controller 558 oversees the operation of the server 112.

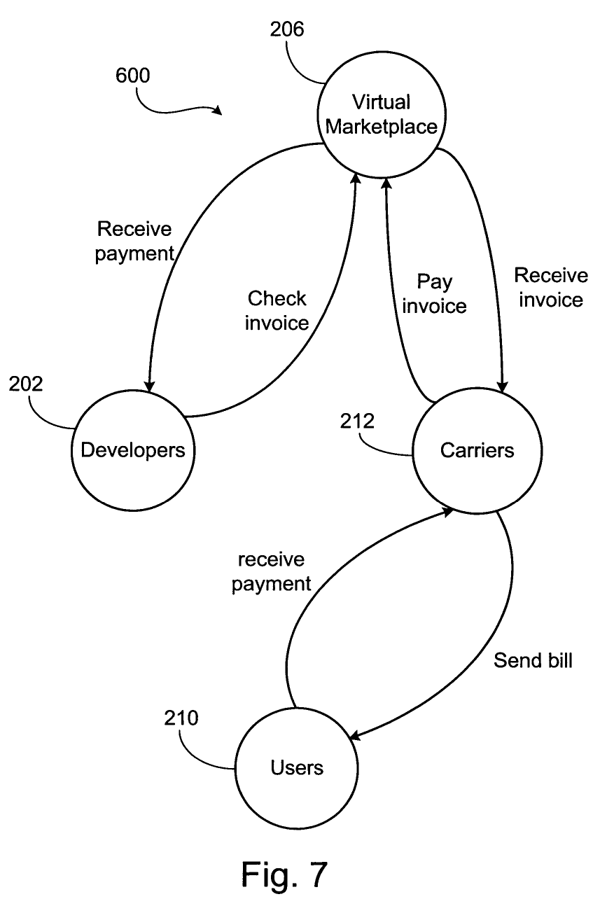

FIG. 7 is a relationship map 600 illustrating the financial relationship between developers 202, the virtual marketplace 206, carriers 212, and end-users 210. The virtual marketplace 206 may support more than one carrier 212 and generates invoices separately for each carrier 212. The invoices generated are available for viewing by the developers 202. Each carrier 212 sends a bill to each individual user 210 who has subscribed or used a product or service from a product catalog, and receives a payment from each user 210. The carrier 212 pays the invoice to the virtual marketplace 206, and the virtual marketplace 206 can collect and distribute proceeds to the developers 202.

The relationship 600 shows the advantage of the present invention. For developers 202, the present invention allows for easy marketing of their products and eliminates the hassle of dealing with individual buyers or the trouble of searching for publishers to carry their products. For carriers 212, the present invention provides a way to make more products available to end users 210, thus providing new venues to generate more profits, without the need to hire a large number of software developers. For users 210, the present invention makes more applications available to the users 210 and maybe be eliminates the need for the users 210 to carry multiple electronic devices, such as pagers, personal digital assistants (PDAs), or even game devices.

It can thus be seen that the system yields a method for providing a virtual marketplace 206 that supports multiple parties, where the virtual marketplace provides access to one or more applications or services from developers 202 and accessible through a wireless network by at least carriers 212 for wireless devices 106 that includes the steps of listing or otherwise providing one or more applications in a virtual marketplace 206 that are accessible by at least the carrier devices on wireless devices 106, receiving a selection from the end-user 106 for interaction with at least one of the applications in the virtual marketplace 206, and generating a bill for the end-user interaction with the at least one application. Such method can further include the steps of receiving proceeds for the end-user interaction, and distributing at least a portion of the proceeds to each developer 202 for each end-user interaction with the at least one application of that developer 202.

As shown FIGS. 3 and 4, the method can also further include the steps of receiving an application from a developer 202, listing the application in a carrier 212 and/or virtual marketplace 202 catalog, displaying the catalog to a end-user 106, receiving a selection from the end-user 106 to download that application, and sending the application to the end-user 106. If so embodied, the method can further include the step of negotiating a price for the application or other service.

If the system is embodied wherein it sends a bill for the end-user interaction, the step of sending the bill for the end-user interaction can be to a network carrier 212 or directly to a wireless device 106. The method of can also include the steps of extracting marketing information from end-user 106 information received from the carrier, generating usage information, or testing the product on a plurality of hardware platforms.

In view of the method being executable on the computer platform of a computer device such as billing server 112 or wireless device 106, the present invention includes a program resident in a computer readable medium, where the program directs a server or other computer device having a computer platform to perform the steps of the method. The computer readable medium can be the memory of the billing server 112, or can be in a connective database. Further, the computer readable medium can be in a secondary storage media that is loadable onto a wireless device computer platform, such as a magnetic disk or tape, optical disk, hard disk, flash memory, or other storage media as is known in the art.

In the context of FIGS. 3, 4 and 5, the method may be implemented, for example, by operating portion(s) of the wireless network to execute a sequence of machine-readable instructions, such as wireless device 106 or the billing server 112. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

1. A method for providing a virtual marketplace that supports multiple parties, the virtual marketplace providing access to one or more applications or services from developers and accessible through a wireless network by wireless devices, comprising the steps of:
listing one or more applications in a virtual marketplace that are accessible by at least carrier devices, each carrier device supporting wireless device communication for the wireless devices of the subscribers for that carrier;
receiving a selection from at least the carrier for interaction with at least one of the applications in the virtual marketplace; and
generating a bill for the interaction with the at least one application.

2. The method of claim 1, further comprising the steps of:
receiving proceeds for the interaction; and
distributing at least a portion of the proceeds to each developer for each interaction with the at least one application of that developer.

3. The method of claim 1, further comprising the steps of:
receiving an application from a developer;
listing the application in a catalog;
displaying the catalog to a end-user;
receiving a selection from the end-user to download that application; and
sending the application to the end-user.

4. The method of claim 1, further comprising the step of negotiating a price for the application.

5. The method of claim 4, wherein the step of negotiating a price occurs between at least a developer and a carrier.

6. The method of claim 1, further comprising the step of extracting information from end-user information received from the carrier.

7. The method of claim 5, further comprising the step of generating usage information.

8. The method of claim 1, further comprising the steps of:
selecting an application at the virtual marketplace from an end-user at a wireless device; and
generating a bill for the end-user interaction with the at least one application.

9. The method of claim 8, further comprising the step of billing a carrier for the end-user interaction.

10. The method of claim 1, wherein the interaction is an application download.

11. A method for providing a virtual marketplace that supports multiple parties, the virtual marketplace providing access to one or more applications or services from developers and accessible through a wireless network by carriers of wireless networks for wireless devices, comprising the steps of;
a creation step of a virtual marketplace that has developer applications accessible to at least carrier devices across a wireless network, the applications downloadable to wireless devices of the carrier;
a selection step for interaction of at least the carrier with at least one of the applications; and
a bill generation step for the interaction with the at least one application;

12. The method of claim 11, further comprising the steps of:
a proceeds collection step for collecting the proceeds of the interaction; and
a proceeds distribution step for distributing at least a portion of the proceeds to each developer for each interaction with the at least one application.

13. A system for providing a virtual marketplace that supports multiple parties, the virtual marketplace providing access to one or more applications or services from developers and accessible through a wireless network by wireless devices, comprising:
one or more wireless telecommunication devices, each wireless device selectively interacting with other computer devices on the wireless network, and selectively downloading and executing applications;
at least one carrier device providing a wireless network to subscribers of that carrier, the carrier device in selective communication with the wireless network and providing one or more downloadable application to the wireless devices of the subscribers of that carrier;
at least one billing server on the wireless network, and
a virtual marketplace hosted by a computer device on the wireless network, the virtual marketplace listing one or more applications in that is accessible by at least the carrier devices,
wherein upon receiving a selection from at least the carrier device for interaction with at least one of the applications, the billing server generating a bill for the interaction with the at least one application.

14. The system of claim 13, further comprising one or more independent developer servers on the wireless network that host applications accessible to the at least one carrier device.

15. The system of claim 13, wherein the virtual marketplace lists the applications available to the carrier in a catalog, displays the catalog to a carrier, and upon receiving a selection from the carrier to download an application, sends the application to the carrier.

16. The system of claim 15, wherein the carrier can negotiate a price with the developer for the application.

17. The system of claim 16, wherein the billing server sends the bill for the interaction to a network carrier.

18. The system of claim 13, wherein the end-user of the wireless device can interact with applications on the virtual marketplace.

19. The system of claim 13, wherein the computer device hosting the virtual marketplace is the billing server.

20. The system of claim 13, wherein the computer device hosting the virtual marketplace is another server on the wireless network.

21. The system of claim 14, wherein the computer device hosting the virtual marketplace is an independent developer server.

22. The system of claim 13, wherein the end-user interaction is an application download.

23. The system of claim 13, wherein the billing server further receives proceeds for the interaction and distributes at least a portion of the proceeds to each developer for each interaction with the at least one application of that developer in the virtual marketplace.

24. A system for providing a virtual marketplace providing access to one or more applications or services from developers and accessible through a wireless network by wireless devices, comprising:
wireless telecommunication means for selectively interacting with other computer devices on the wireless network and selectively downloading and executing applications, the wireless telecommunication means having a carrier therefor that provides wireless communications support;
an application providing means hosted by a computer device on the wireless network for listing one or more applications that are accessible by carriers of the wireless telecommunication means; and
billing means on the wireless network for billing for interactions with at least one of the applications on the application providing means, the billing means further generating a bill for the interaction with the at least one application.

25. A server for providing a virtual market place for carriers that provide wireless services to wireless devices, the server billing for at least carrier interaction with one or more applications supported in the virtual marketplace that are accessible by wireless devices, the applications created by one or more developers, each carrier selectively downloading and providing application to the wireless devices of that carriers respective wireless subscribers, wherein upon the virtual marketplace receiving a selection from a carrier for interaction with at least one of the applications, the billing server generating a bill for the interaction with the at least one application.

26. The server of claim 25, wherein the carrier can negotiate a price with the developer for the application.

27. The server of claim 25, wherein the server sends the bill for the interaction to a network carrier.

28. The server of claim 25, wherein the server further allows wireless devices to interact with resident applications.

29. The server of claim 25, wherein the server further collects the proceeds from the interactions and distributes appropriate portions of the proceeds to developers of applications that were interacted with by at least the carriers.

30. A computer program that when executed by a computer device on a wireless network having one or more carriers providing wireless communication services to wireless devices, provides a virtual marketplace that supports multiple parties and provides access to one or more applications or service through causing the computer device to perform the steps of:
listing one or more applications in the virtual marketplace that are accessible by the carriers to host as downloadable to the wireless devices of that carrier;
receiving a selection from an carrier for interaction with at least one of the applications;
generating a bill for the interaction with the at least one application;

31. The program of claim 30, wherein the program further causes the computer device to perform the steps of:
receiving proceeds for the interaction; and
distributing at least a portion of the proceeds to the developer for each interaction with the applications of that developer.

32. The program of claim 30, wherein the program further causes the computer device to perform the step of negotiating a price for interaction with the application by the carrier.

33. The program of claim 30, wherein the program further causes the computer device to perform the step of sending a bill for the interaction to another computer device on the network.
